(19) United States
(12) Patent Application Publication
(10) Pub. No.: US 2022/0270024 A1
(43) Pub. Date: Aug. 25, 2022

(54) Method and system to predict stakeholder project impact

(71) Applicant: Gloria J. Miller, Wiesloch (DE)

(72) Inventor: Gloria J. Miller, Wiesloch (DE)

(21) Appl. No.: 17/676,222

(22) Filed: Feb. 20, 2022

Related U.S. Application Data
(60) Provisional application No. 63/151,734, filed on Feb. 21, 2021.

(51) Int. Cl. G06Q 10/06; G06Q 10/10

(52) U.S. Cl. CPC G06Q 10/063114; G06Q 10/103; G06Q 10/06312

(57) ABSTRACT

This disclosure describes a method and system to use electronic communications to predict project outcomes. Projects provide a context where the participants are known, and there is a given scope that places boundaries around their communications. The stakeholders work toward a common goal that provides a baseline for monitoring progress and predicting the likelihood of reaching the goal. Data are received from a first application that is electronic communications, such as email and calendar events. The data are scored and classified according to computational and text data mining models. The results from the models are displayed in lists or visual reports and used to assess the adequacy of stakeholder communications and predict a project outcome.

### CROSS-REFERENCE TO RELATED APPLICATIONS

This application claims the benefit of priority under 35 U.S.C § 119(e) to U.S. Provisional Application No. 63/151,734, filed Feb. 21, 2021, entitled “Project Electronic Communication Monitoring and Adequacy Prediction,” which is incorporated herein by reference in its entirety.

### FIELD OF THE INVENTION

The present application relates to modeling, measuring, and managing communications between project stakeholder to predict the project outcome.

### BACKGROUND

Projects are temporary organizations with a set of stakeholders working together over a limited, pre-determined period of time for a given activity. Communication is one of the main factors that impact the success or failure of a project. Communication is complex for several reasons. First, different stakeholders have different perspectives on the meaning of project success: project teams focus on delivering according to contracts with their customers, customers are interested in flexible adaptation to meet changing needs, and suppliers are interested in profits and new work. Communication is across multiple organizations and multiple organizational boundaries. Different stakeholders require different content of communication, at different frequencies, and with different medium (e.g., email, face-to-face, telephonically).

Therefore, there is a need to balance social and technical content of communications during a project. The type of relationship between the parties determines the media that should be used for the communication. The challenge is for project to have stable communication practices between parties within the project. This requires a multi-dimensional approach to managing communication to ensure project success, including the evaluation of individual tasks responsibilities, flexibility in changing circumstances, open exchange of information, and routine communications using different formats and media.

### SUMMARY

This disclosure describes a method and system to use electronic communications to predict project outcome. Projects provide a context where the participants are known, and there is a given scope that places boundaries around their communications. Data are received from a first application that is electronic communications, such as email and calendar events. The data are scored and classified according to computational and text models. The results from the models are displayed in lists or visual reports and used to access the adequacy of stakeholder communications and to predict a project outcome. That the stakeholders are working toward a common goal provides a baseline for monitoring progress towards that goal and predicting the likelihood of reaching it.

The present disclosure overcomes challenges with existing methods, systems, and practices associated with predicting project outcomes by focusing on the communication patterns. It incorporates computational models that recommend communications patterns in projects and factors for evaluating the efficiency and effectiveness of that communication. It provides a method and system for preparing electronic communication data, scoring and classifying the data using text and computational models, and using the results to predict the project outcome based on the adequacy of the stakeholder communication.

The method and system provide a unique and novel use of data produced during routine electronic communications to score, classify, and report on communication, to predict adequacy based on communication patterns to achieve a project outcome.

Until now, digital trace communication data has not been consolidated and presented for predictive project management.

### FIGURES

FIG. 1 is a block diagram illustrating the electronic communication input from a first application and the process steps in the system.

FIG. 2A illustrates the flow and content of the electronic communication a first application.

FIG. 2B is an entity relationship diagram for the communication table structure.

FIG. 3 is a block diagram that depicts the process flow for the data preparation module.

FIG. 4 is a block diagram illustrating the online scoring programs.

FIG. 5 is an exemplary screen-snapshot of a prediction monitor.

FIG. 6 is a block diagram of the configuration components.

FIG. 7 is a block diagram depicting an integrated view of the computing environment modules described herein.

### DETAILED DISCLOSURE

This disclosure describes a system, method, and computer-readable media for preparing electronic communication data, scoring and classifying the data using text and computational models, and using the results to predict the project outcome based on the adequacy of stakeholder communication. The system and method support data-driven and digital workflows for performance management, planning, and forecasting. The disclosed use of artificial intelligence is suitable for navigating the numerous potential project configurations to facilitate project success. The data processing, computations, and functionality described herein is envisioned to be performed by hardware, software, and firmware. The computations and functions must be performed on a specially-programmed computer designed and configured for complex computations and data processing.

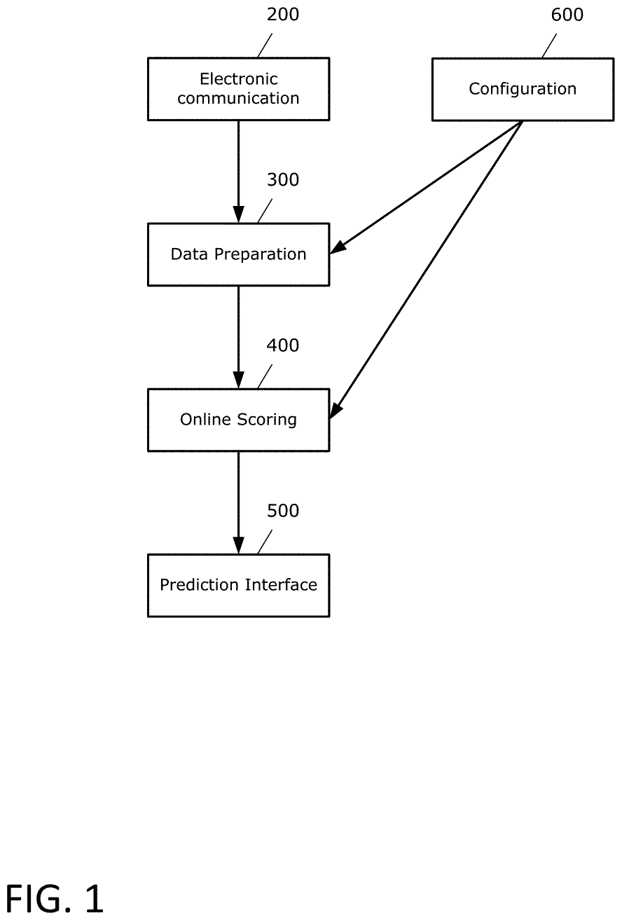

FIG. 1 illustrates the process flow where the electronic communication 200 are received from the first application, processed in the data preparation module 300, the online scoring module 400, and the results presented in the prediction interface 500. The configuration module 600 is used to set up the system for data preparation, scoring, classification, and prediction.

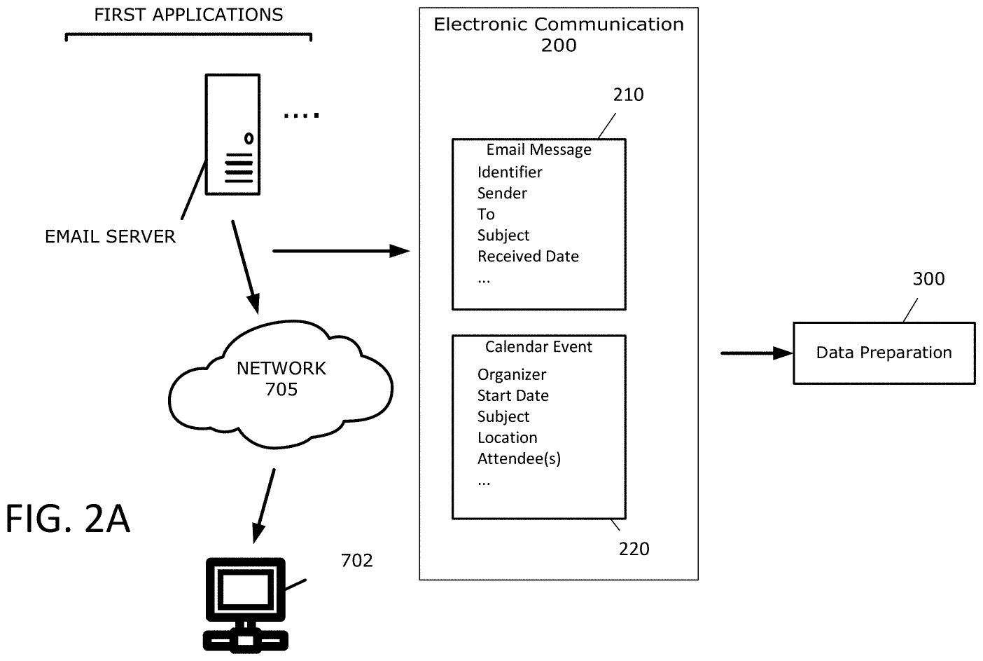

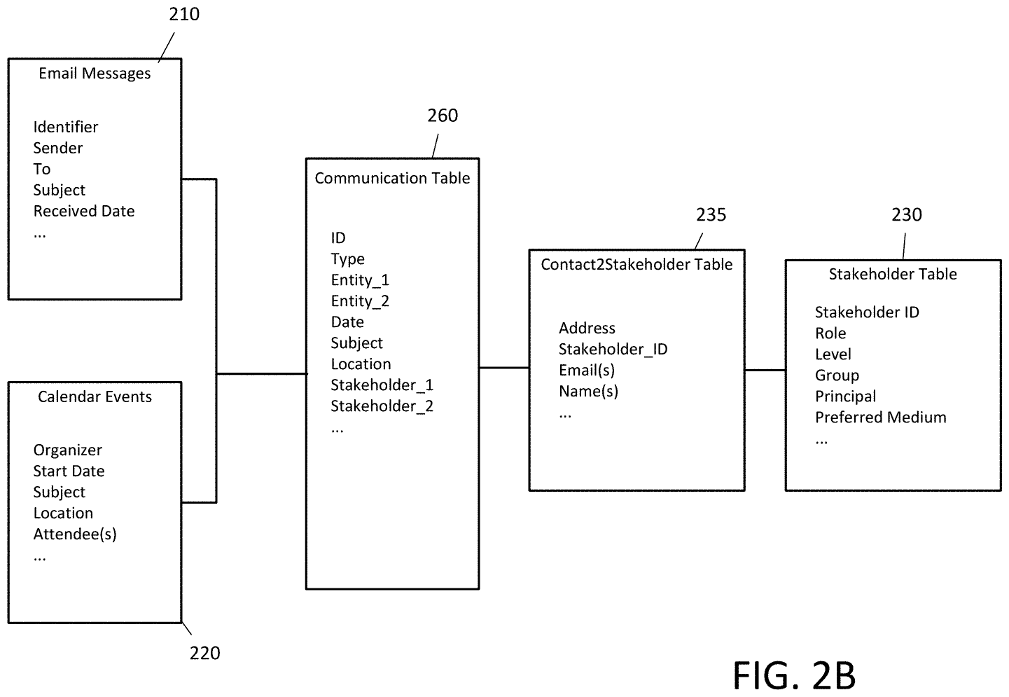

FIG. 2A illustrates the flow and content of the electronic communication 200 from one or more first applications. The electronic communication 200 are provided from one or more first applications over a network 705 with a multitude of data attributes as metadata to a computing devices 702. The electronic communication 200 is initiated by a sender and transmitted to one or more recipients. Examples of the electronic communication 200 include email messages 210 and calendar events 220. Examples of the first applications include an electronic mail server, web service, social media platforms, or telephone. The electronic communication 200 are processed through the data preparation module 300 and stored in the communication table 260.

### Dataset Tables

FIG. 2B illustrates the logical database structure for the relationship between the email messages 210, the calendar events 220, the communication table 260, the contact2stakeholder table 235, and the stakeholder table 230. Each table is stored in a dataset that is stored in a database or filesystem file.

The communication table 260 contains the metadata from the email messages 210 that will be evaluated as written communications. The email metadata are provided by a first application and include the following minimal attributes: (a) subject, (b) identifier, (c) sender, (d) to, and (e) received date. These attributes are stored in the communication table 260 as (a) subject, (b) ID, (c) entity_1, (d) entity_2, and (e) date, respectively. There is one table row entry per message and email recipient in the communication table 260. The communication type attribute in the communication table 260 will be set to “email” for each entry to identify the source of the electronic communication 200.

The communication table 260 contains the metadata for calendar events 220 that will be evaluated as verbal communications. The calendar attributes are provided by a first application and include the following minimal attributes: (a) subject, (b) organizer name, (c) one or more attendee names, (d) location identifier, and (e) start date. A unique identifier is generated and added to an attribute. These attributes are stored in the communication table 260 as (a) subject, (b) entity_1, (c) entity_2, (d) location identifier, (e) date, and (f) ID, respectively. There is one table row entry per calendar event and attendee name in the communication table 260. The communication type attribute in the communication table 260 will be set to “calendar” for each entry to identify the source of the electronic communication 200.

The location table 225 contains a unique list of locations for the calender events from the calendar events 220. The location attributes include (a) a location identifier, (b) a location classification if it is a face-to-face event, virtual event, or both, and where appropriate and available other optional attributes such as (c) a geographic tag for the three-digit international standards organization country code, (d) the city, state or other geographic tagging information such as the longitude and latitude.

The stakeholder table 230 uniquely identifies a stakeholder. A stakeholder may be a person, organization, or a collective such as a team. Each stakeholder should have (a) a unique identifier (ID), (b) a project role, (c) an organizational level, (d) a group, (e) an binary entry if they are a principal, and (f) one or more optional attributes. The project role may represent a high-level or a detailed role title based on the stakeholder's accountability or responsibility within the project. The roles may be dynamically defined; as an example, the following could be defined as the roles, for example, sponsor, steering committee, project management, team member, service provider, and others. The group is for a collection of stakeholders, and it is useful for reporting purposes. Examples for the group could be performing, operating, funding, users. The principal attribute indicates if the stakeholder's communications are important to the overall success of the project; that is, if yes, the predicted adequacy score is a deciding factor in when cumulating the overall project score.

The contact2stakeholder table 235 contains one or more addresses for a stakeholder. An address is the sender email, receiver email, calendar attendee name, calendar originator name. Since a single stakeholder may be represented with multiple addresses or name spellings, a single stakeholder may have multiple contact2stakeholder entries. Each contact2stakeholder entry should represent one stakeholder that is identified by the stakeholder identifier. The contact2stakeholder table 235 maps each address to one and only one entry in the stakeholder table 230 by the stakeholder identifier. The stakeholder is related to the communication table 260 by looking up the entity_1 or entity_2 attributes in the contact2stakeholder table 235 address and selecting the corresponding stakeholder identifier; the respective stakeholder identifiers are stored in stakeholder_1 for entity_1 and stakeholder_2 for entity_2.

The project table 240 identifies attributes about the project and includes (a) a unique project identifier, (b) project name, (c) other optional project attributes. The project may have a milestone table 242 that identifies important delivery dates. The milestone table 242 should include the following attributes: (a) unique milestone identifier, (b) subject, (c) milestone label, and (d) date. The project may have a phase table 244 that identifies time periods with start and end dates for the project. The time periods may represent project phases or iterations for agile projects, sprints for a scrum, etc. The phase table 244 should include the following attributes: (a) unique phase identifier, (b) subject, (c) phase label, (d) start date, and (e) end date. The project may have an event table 246 that identifies events that occur that are not milestones or project phases. The event table should include the following attributes: (a) unique event identifier, (b) subject, (c) descriptive event label, and (d) date. The phase table 244, milestone table 242, and event table 246 may be physically represented as one consolidated table or as individual tables.

The stakeholder2project table 250 identifies the assignment of a stakeholder table 230 record to a project table 240 record. Each record in stakeholder2project table 250 should include a mapping of the stakeholder identifier and the project identifier for each stakeholder assigned to the project.

The topic table 255 identifies a mapping of subject content to communication content. It can be created by executing the topic program 430, or it can be compiled manually. The topic table 255 must contain attributes for (a) the topic, (b) a topic identifier, (c) a label, and (d) a topic group. The topic group classifies the subjects according to project communication themes: status (e.g., status, issues, changes, next steps), updates (e.g., achievements, issues, changes), analysis (e.g., measures and project trends).

Other tables are managed dynamically and described in later sections: the vertex table 402, edge table 404, baseline table 406, and patternResults table 408.

### Data Preparation

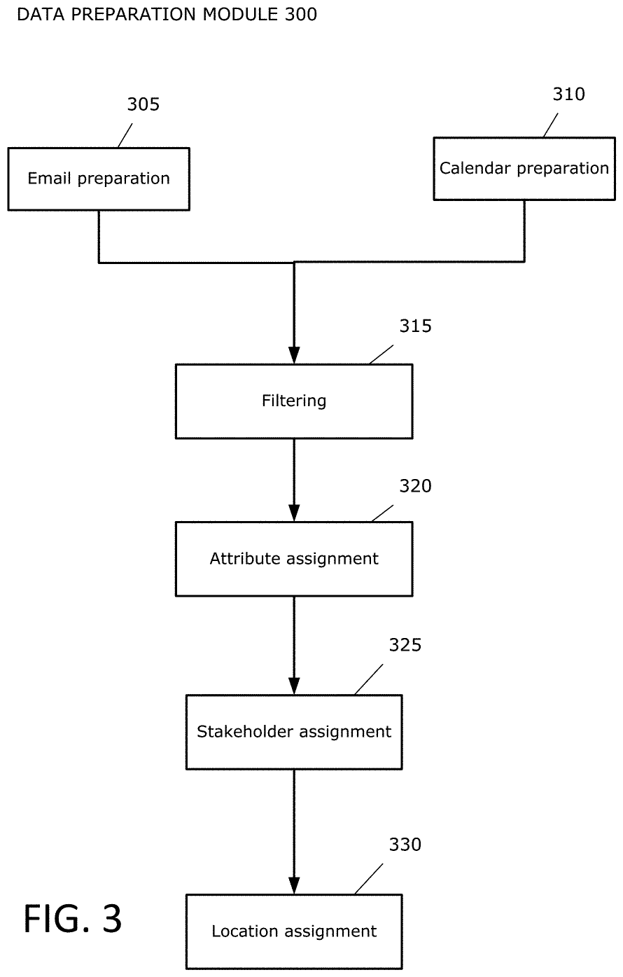

FIG. 3 illustrates the data preparation module 300 process flow that can be a batch process or a streaming process to create the commAnalysis table 265. The output of the data preparation module 300 is the commAnalysis table 265 that has attributes from the communication table 260, the stakeholder table 230, the location table 225 as described in the following steps.

The first set is to populate the communication table 260 with the electronic communication 200. For the batch process, all accessible email and calendar entries are extracted from the first application and written into a communication table 260. Records in the communication table 260 that do not have a corresponding record in the stakeholder2project table 250 for entity_1 or entity_2 based on an address lookup in the contact2stakeholder table 235 are deleted. For a streaming process, incoming the electronic communication 200 entries from the first application with no corresponding address in the contact2stakeholder table 235 are not stored in the communication table 260. In summary, the communication table 260 contains the subset of the electronic communications 200 that will be analyzed as belonging to stakeholders of the project.

For the email preparation 305, the email messages 210 are extracted from the first application with one record for each email recipient and stored in the communication table 260. The stakeholder_1 and stakeholder_2 attributes are populated with the stakeholder identifiers that correspond to the email address in the contact2stakeholder table 235 for entity_1 and entity_2, respectively. The communication type attribute is set to “email.”

For the calendar preparation 310, the calendar events 220 are extracted from the first application with one record for calendar event and each attendees' name. The stakeholder_1 and stakeholder_2 attributes are populated with the stakeholder identifiers that correspond to the address in the contact2stakeholder table 235. The type attribute is set to “calendar.” Other types of communications would need to be configured based on the type, structure, and metadata provided by the first application.

The filtering 315 process is responsible for sub-setting the entries in the communication table 260 by deleting for batch processing or screening for streaming processing.

The next step is the attribute assignment 320 for dates. Additional attributes for the year, month, week, day of the month, day of the week are assigned to the communication table 260 based on the date.

The next step is the stakeholder assignment 325 for project attributes. The attributes from the stakeholder table 230 are joined to the communication table 260 twice: once for stakeholder_1 and again for stakeholder_2. The unique stakeholder identifier is used to join the tables. The attributes names in the join are created to identify them as belonging to stakehoder_1 or stakeholder_2. For example, Role_S1, Group_S1, Level_S1, Principal_S1, Role_S2, Group_S2, Level_S2, Principal_S2 would refer to the attributes for stakeholder_1 and stakeholder_2, respectively.

In the location assignment 330, the location table 225 is outer joined to the communication table 260 by the location identifier. That is, all records in the communication table 260 are retained, and the records without a location will contain empty data for the location attributes.

### Online Scoring

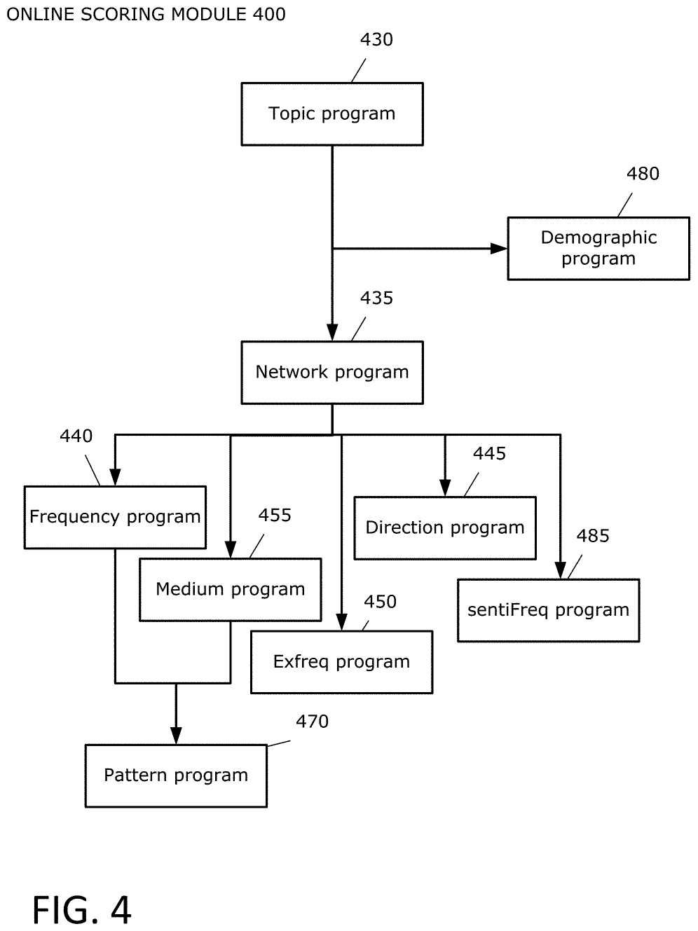

FIG. 4 illustrates the online scoring module 400 that performs the following actions. The first step uses the commAnalysis table 265 from the data preparation module 300 to execute the computation or text model that is a data mining program in the following order: the topic program 430, network program 435, any further computation modules that exist: the frequency program 440, the network program 435, the direction program 445, and the exfreq program 450, then sentiFreq program 485, and the pattern program 470.

The principal level of analysis is the vertex that will be used for computations and analysis in the online scoring module 400; the level of analysis vertex is decided by a vertex parameter. The vertex can be any dyadic attribute that exists in the commAnalysis table 265, e.g., stakeholder role, stakeholder group, stakeholder identifier. The stakeholder identifier is not optimal as it may be possible to identify individual persons in small project that introduces privacy concerns that would have to be mitigated. In the exemplary for this disclosure, the role will be vertex (e.g., vertex_1 will refer to the role for stakeholder_1, vertex_2 for the role of stakeholder_2).

The topic program 430 analyzes the subject of the commAnalysis table 265 to identify recurring topics or themes. There are alternative methods for assigning topics from the subject in the commAnalysis table 265. Using a topic model that is a data mining program that can run in data mining applications such as R, SAS® is one method. Another method is to perform keyword counts and manually assign topics. Regardless of the method used to populate the topic table 255, the topic program 430 assigns a topic identifier, topic label, and topic group to records in the commAnalysis table 265.

Data mining application for topic model assignment is conducted in three steps. Step one is to analyze the subjects and estimate the number of topics that should be defined. The second step is to create the list of topics with the topic identifier and the topic label based upon the subjects. The results of the second step are stored in the topic table 255 with the corresponding attributes. The topic group attribute should be added to the table to automatedly or manually assign the topics. The third step is to assign the topic identifier, topic label, and topic group to the records in the commAnalysis table 265 by scoring the subject attribute. Scoring should identify the subjects that most closely reflect the content of the topic. Steps one and two should be executed for the initial set-up; they are optional after the first execution. Step three is incorporated into the online scoring module 400.

The network program 435 computes the network analysis values using a data mining application such as R, SAS®. First, the program organize a vertex list by extracting a distinct list of records from the commAnalysis table 265 for vertex_1 and doing the same extraction for vertex_2; combining the two lists into a single table, the vertex table 402, and adding a unique identifier; creating an edge table 404 with a count of records based on dyadic relationships in the commAnalysis table 265 between vertex_1 and vertex_2, edge table 404; computing network metrics based on the vertex table 402 and the edge table 404; saving the network metrics to the vertex table 402. The network metrics include betweenness, indegree, outdegree, degrees, closeness, network density, network size, bins based on the closeness, and bins based on the betweenness.

The frequency program 440 computes the frequency of communication between two vertexes in the commAnalysis table 265. The frequency computation counts the number of transactions between two vertexes to determine the frequency as daily, weekly, monthly, multiple times a day, or ad hoc for fixed interval communication. It counts the frequency communication given the existence of the milestone table 242 by milestone date; given existence of the phase table 244 by phase end for variable interval communication; given existence of the event table 246 by event date for variable interval communication; The frequency is added as an attribute to the edge table 404. The total frequency counts for each theme are separated or cut into a four-point scale with the minimum frequency being a one on the scale and the maximum frequency being a four. The results are stored in the edge table 404 for the dyadic relationship, and the maximum score per vertex is stored in the vertex table 402.

The direction program 445 computes a score depending on the direction of the communication between vertexes in the commAnalysis table 265. The module logic is based on comparing the level of vertex_1 and vertex_2. If the vertex_1 level is greater than the vertex_2 level, then the score is 3; if less than, then the score is 1; and if equal, then the score is 2. The meaning of the score may be interpreted or dynamically changed; defaults assignment is 1 is downwards communication, 2 is lateral communication, and 3 is upwards communication. The direction is added as an attribute to the edge table 404.

The exfreq program 450 computes frequencies of engagement for vertexes in phase, events, or milestones using one or all of the following tables combined with the commAnalysis table 265 by date: the event table 246, the milestone table 242, the phase table 244. The program does a date match between the two tables: for example, the number of records in the commAnalysis table 265 where the date is the same date as a date in the event table 246, the project end date in the phase table 244, or the milestone date in the milestone table 242. The program counts the number of transactions each vertex was included in communication on the event, phase, or milestone date as vertex_1 or vertex_2. Based on the frequency, the program assigns a scale from one to four and a corresponding label value of “none,” “one,” “some,” or “all.” The results are stored in the edge table 404 for the dyadic relationship, and the maximum score per vertex is stored in the vertex table 402. The event, milestone, and phase results are stored in separate attributes.

The medium program 455 computes frequency counts for records in the commAnalysis table 265 by the communication type and by location classification to provide the communication type frequency and the location frequency. The frequency computation includes the number of transactions for the communication type of email that is evaluated as written communication and of calendar that is evaluated as verbal communication. The frequency count by location classification may be computed for additional insights such as face-to-face or virtual. The frequency counts are grouped by vertex_1 for analyzing email senders or meeting organizers; vertex_2 for email receivers or meeting participants. The verbal attribute frequency count is the sum of the frequency for vertex_1 and for vertex_2 for the same stakeholder; likewise, the written attribute is similarly computed. The medium attributes are in the computer memory and not persisted in table storage.

The sentiFreq program 485 computes the sentiment analysis values using a data mining application such as R, SAS®. First, the program computes the sentiment for the subject in the commAnalysis table 265 using a dictionary-based sentiment. In this exemplar, it uses the QDAP sentiment dictionary from the R software package. Then it computes a sentiment direction by assigning integer values to the sentiment response: 0 or neutral, 1 for positive, and −1 for negative. Then, it assigns the cumulative sum of the sentiment direction to the edge table 404 grouped by vertex_1 and vertex_2.

The pattern program 470 scores the relevance to the record in the commAnalysis table 265 to the project outcome based on quantitative methods such as factor analysis, cluster analysis, regression analysis. The program computes the score on a scale depending on a formula or a simple average of the scores produced in the online scoring module 400. The scale is from low values for not present to high values for highly present. The predicted adequacy score is a score for the probability the communication pattern will result in a successful project outcome. The comparison model is by vertex, variable, mean, and standard deviation stored in a baseline table 406. Other comparison models can be configured.

For illustration, the aspects of the communication model from Mueller (2003) are used in the baseline table 406, as shown in the table. The values for the variable scores are stored in the vertex table 402 or computed by the pattern program 470. The variable score is based on a simple average and the scores are compared with the mean values. For example, the scale value for the medium variable is seven-points; the written frequency count is transformed into a seven-point score and compared against this scale value (for example, in R software the cut function is used to sequence the variable by a standard deviation of one). With a standard deviation parameter of one, the rating from 5 to 7 is green, 4 is yellow, and 3 and less is red. For variables that require composite scores, the average of the scores is computed, e.g., frequency variable interval is the average of phase score and milestone score, which are five-point scales. The predicted adequacy score is computed using the formula: adequacy score=((written+verbal)+(fixed interval+variable interval)*3+(written status+verbal update, average of written and verbal analysis))/11. The weight is given to the variables based on this significance. The performance range is 4.8 as mean and 0.63 as the standard deviation.

Baseline table 406 is given as follows.

| | | | Standard |
|---|---|---|---|
| Variable | Value | Mean | Deviation |
| Medium | Written | 6.30 | 0.96 |
| Medium | Verbal | 5.99 | 0.99 |
| Frequency | Variable Intervals | 2.80 | 0.60 |
| Frequency | Fixed Intervals | 3.00 | 0.60 |
| Contents | Written status | 6.16 | 0.29 |
| Contents | Verbal update | 5.34 | 0.17 |
| Contents | Written and verbal analysis | 4.01 | 0.80 |

The results from the pattern program 470 are stored in the patternResults table 408. The scores are stored for each vertex and for the overall project. The score for the overall project is based on the minimal value for key stakeholders as identified by the principal attribute in the stakeholder table 230.

The demographics program 480 computes statistics as follows. The computation produces from the commAnalysis table 265, the start date as a minimum date, end date as a maximum date, duration between start and end dates, number of entries as count of transactions, number of entities as the count of unique entities, number of roles as count of unique roles assigned to the entities. Other demographics may be produced, such as the number of phases, milestones, topics.

### Outputs

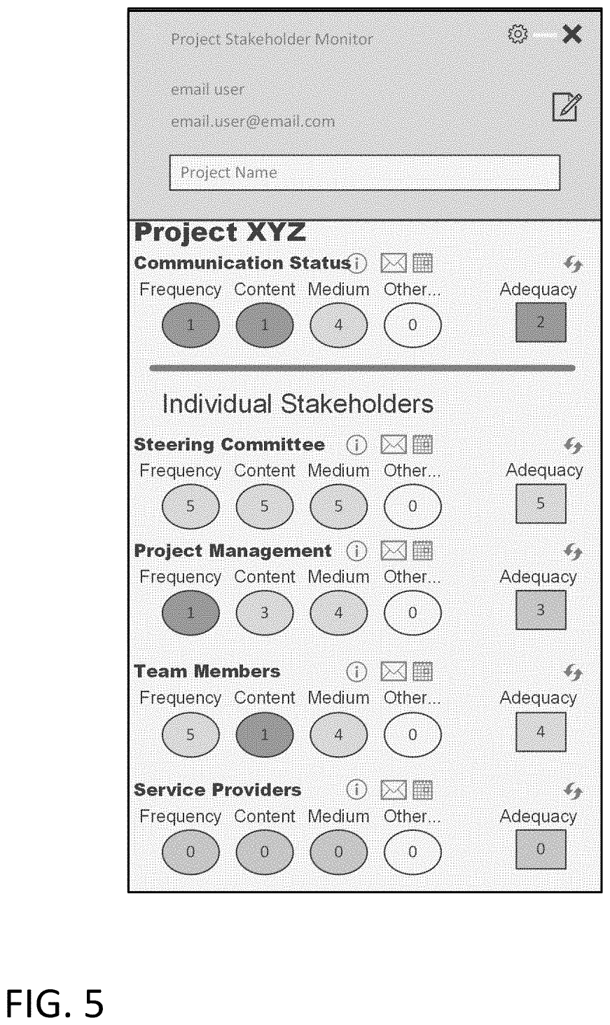

FIG. 5 illustrates the prediction interface 500 that reports the state of communication by role and project. It can be used to refresh the results for the same project or query a new project. The prediction interface 500 consolidates the results of the computation modules, visually reports the scores from the topic program 430 as content, frequency program 440 as frequency, medium program 455 as a medium, and pattern program 470 as the predicted adequacy of the communication pattern.

The prediction interface 500 includes a display area that is shown on computing devices 702. The user can interact with the display area with a user interface 729, such as the display touchscreen, a keyboard, or a mouse. The user can select one of the icons on display to trigger an action. For example, selecting an information icon to display information produced by the demographics program 480; an email icon to display information produced by the pattern program 470 for email messages 210; a calendar icon to display information produced by the pattern program 470 for the calendar events 220. The results displayed would be filtered for the selected role or for the entire project.

The prediction interface 500 reports show the frequency, content, medium, and other scores in a color-coded circle with a large, centered number. The large, centered number represents the score for the item. The colors are coded from green for positive, yellow for neutral, red for negative, and grey for not relevant to a signal on the performance of the item. The predicted adequacy score is shown in a color-coded square with a large, centered number. The positive value is the median for the score, and the number standard deviation on either side of the median establishes the neutral and negative performance ranges. The number of standard deviations is a parameter value.

Additional visualization reports are possible with the data collected for the communication analysis, e.g., reports on network linkages, including properties such as symmetry, centrality, direction, reciprocity, and multiplexity; network measures; expert usage. The communication data may be used for social network analysis to help project managers gauge the effectiveness of specific roles and actions. The communication data and predictive capabilities provided herein are useful to visualize how stakeholders interaction on projects; understand, measure and analyze individual communication linkages; identify isolated stakeholders to take corrective actions and improve the performance; understand and evaluate how communication changes during the course of a project; and provide insights into the identification and analysis of project stakeholders in a holistic manner.

### System Configuration

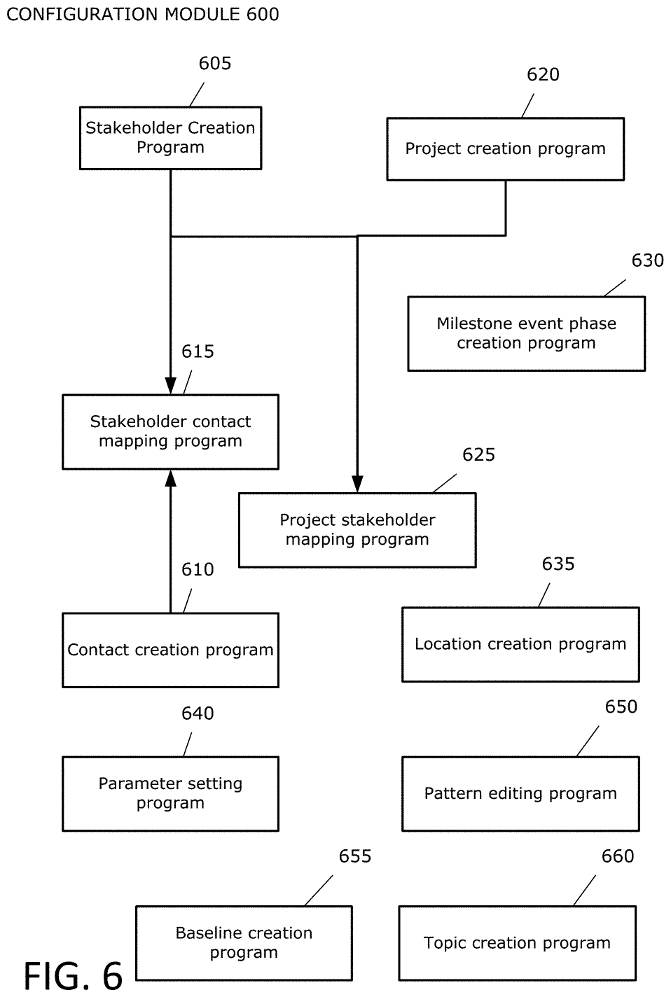

FIG. 6 illustrates activities to configure the system and, when relevant, the relationship between the activities. The configuration module 600 is used to set up the system for data preparation, scoring, classification, and prediction. Before the first use, the system should be populated with details about the contacts and the project attributes. Off-the-shelf software for manipulating databases and hypertext markup language may be used for this purpose. Alternatively, the data preparation module 300 and online scoring module 400 may be integrated into off the shelf project management software and solutions that capture stakeholder and project relationship data.

The set-up steps include the following: The stakeholder creation program 605 to populate the attributes in the stakeholder table 230 with the details from the entities (people, organization, teams) in the projects. The contacts creation program 610 to populate the attributes in the contact2stakeholder table 235 with the email accounts and names from email messages 210 and the calendar events 220. The stakeholder contact mapping program 615 to map the records to stakeholder table 230 by including the stakeholder identifier in the contact2stakeholder table 235. The contact2stakeholder table 235 may have multiple entries for a stakeholder. The email addresses and calendar names relevant to the project should have an entry in the contact table. The project creation program 620 to populate the project table 240 with the details from the project. The stakeholder project mapping program 625 to populate the stakeholder2project table 250 with one record for assignments of stakeholders to projects. The milestone event phase creation program 630 to, if relevant, populate the milestone table 242, phase table 244, and event table 246. The location creation program 635 to populate the location table 225 with details from the calendar locations.

Set the vertex parameter based on the desired level of analysis; the parameter should be set to an attribute from the project or the stakeholder table, e.g., role, organization. The parameter setting program 640 to set the standard deviation parameter to a numeric value to determine the rating range for status indicators: one is the default value for the standard deviation parameter. The pattern editing program 650 to, if relevant, edit the pattern program 470 to change or update model details. The baseline creation 655 to populate the baseline table 406. If using data mining topic models, the topic creation program 660 to execute steps one and two in the topic program 430 and add the group to the table.

For using the system, the system should be executed on a first application email account that processes electronic communications. The volume, content, and medium analysis will be determined by how central the email account is in the project communications. Thus, the email account should be the recipient of project-related emails. For example, the email account could be a shared group email account that is the recipient and distributor of project emails. Alternatively, the email account could be that of the project manager, the project management office, or the project communicator. The system could be configured for batch processing—periodic initiation—or for processing transactions as they stream in from the electronic communication account.

### Computing Environment

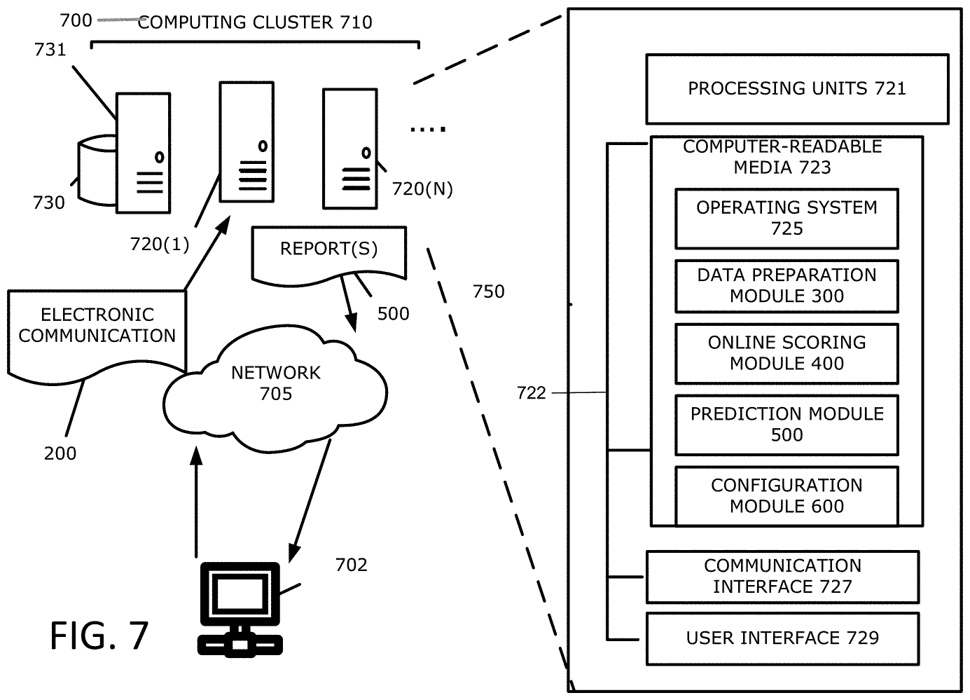

FIG. 7 illustrates a computing environment 700 in which the system described herein can be hosted, operated, and used. In the figure, the computing devices 702, computer servers 720(1)-720(N), and database servers 730 can be used individually or collectively, where N is an integer greater than or equal to one. Database servers 730 is comprised of computer servers 720(1)-720(N) and database software for storing, manipulating, and retrieving structured or non-structured data. Within this disclosure, the data tables maybe implemented in database management systems (DBMS) known in the art such as, for example, MySQL, PostgreSQL, SQLit, Microsoft SQL Server, Microsoft Access, Oracle, SAP, SAS datasets, or any other type of database.

Although computing devices 702 is illustrated as a desktop computer, computing devices 702 can include diverse device categories, classes, or types such as laptop computers, mobile telephones, tablet computers, and desktop computers and is not limited to a specific type of device.

Computer servers 720(1)-720(N) can be computing nodes in a computing cluster 710, for example, cloud services such as Dreamhost, Microsoft azure, or amazon web services. Cloud computing is a service model where computing resources are shared among multiple parties and are made available over a network on demand. Cloud computing environments provide computing power, software, information, databases, and network connectivity over the Internet. The internet is a computer data network that is an open platform that can be used, viewed, and influenced by individuals and organizations.

Within this disclosure, the computing environment refers to the computing or database environment made available as a cloud service. Resources including processor cycles, disk space, random-access memory, network bandwidth, backup, resource, tape space, disk mounting, electrical power, etc., are considered included in the cloud services. In the diagram, the computing devices 702 can be clients of computing cluster 710 and can submit programs or jobs to computing cluster 710 and/or receive job results or data from computing cluster 710. Computing devices 702 is not limited to being a client of computing cluster 710 and maybe a part of any other computing cluster.

Computing devices 702, computer servers 720(1)-720(N), or database servers 730 can communicate through other computing devices via one or more network 705. Inset 750 illustrates the details of computer servers 720(N). The details for the computer servers 720(N) are also representative examples for other computing devices such as computing devices 702 and computer servers 720(1)-720(N). Computing devices 702 and computer servers 720(1)-720(N) can include alternative hardware and software components. Referring to FIG. 7 and using computer servers 720(N) as an example, computer servers 720(N) can include computer memory 724 and one or more processing units 721 connected to one or more computer-readable media 723 via one or more of buses 722. The buses 722 may be a combination of a system bus, a data bus, an address bus, local, peripheral, or independent buses, or any combination of buses. Multiple processing units 721 may exchange data via an internal interface bus or via a network 705.

Herein, computer-readable media 723 refers to and includes computer storage media. Computer storage media is used for the storage of data and information and includes volatile and nonvolatile memory, persistent and auxiliary computer storage media, removable and non-removable computer storage technology. Communication media can be embodied in computer-readable infrastructure, data structure, program modules, data signals, and the transmission mechanism.

Computer-readable media 723 can store instructions executable by the processing units 721 embedded in computing devices 702, and computer-readable media 723 can store instructions for execution by an external processing unit. For example, computer-readable media 723 can store, load, and execute code for an operating system 725, programs for data preparation module 300, the online scoring module 400, the configuration module 600, and the prediction interface 500, and for other programs and applications.

A skilled artisan may implement the functionality in differing ways using multiple programming languages and, in some embodiments, data mining software. The implementation decision should not be considered a departure from the scope of the disclosure. The embodied programs may be implemented in software, firmware, or hardware, or a combination. The program code may be a procedure, a function, a program, a routine, a software package, a class, an object, a data structure, a program statement, or any combination. The code may be sequenced together or coupled with other code segments, data arguments, or parameters, or memory components.

One or more processing units 721 can be connected to computer-readable media 723 in computing devices 702 or computer servers 720(1)-720(N) via the communication interfaces 727 and network 705. For example, program code to perform steps of the flow diagram in FIG. 7 can be downloaded from the computer servers 720(1)-720(N) to computing devices 702 via the network and executed by one or more processing units 721 in the computing devices 702.

Computer-readable media 723 of the computing can store an operating system 725 that may include components to enable or direct the computing devices 702 to receive data via inputs and process the data using the processing units 721 to generate output. The operating system 725 can further include components that present output, store data in memory, transmit data. The operating system 725 can enable end-users of user interface 729 to interact with computer servers 720(1)-720(N). The operating system 725 can include other general-purpose components to perform functions such as storage management and internal device management.

Computer servers 720(1)-720(N) can include a user interface 729 to permit the end-user to operate the configuration module 600 and interact with the prediction interface 500. An example of user interaction through the processing units 721 of computing devices 702 receives input of user actions via user interface 729 and transmits the corresponding data via communication interfaces 727 to computer servers 720.

User interface 729 can include one or more input devices and one or more output devices. The output devices can be configured for communication to the user or other computing devices 702 or computer servers 720(1)-720(N). A display, a printer, audio speaker are example output devices. The input devices can be user-operated or receive input from other computing devices 702 or computer servers 720(1)-720(N). Keyboard, keypad, mouse, and trackpad are examples of input devices.

Dataset 731 is electronic content having any type of structure, including structured and unstructured data, free-form text, or tabular data. Structured dataset 731 include, for example, one or more data items, also known as columns or fields, and one or more rows, also known as observations. Dataset 731 include, for example, free-form text, images, or videos as unstructured data. The prediction interface 500 results are physical or electronic documents with content produced as the results of executing programs for the prediction interface 500 and other programs and applications.

### SUMMARY

The outputs of the system are useful for people involved in project governance to ensure that adequate communications are occurring with project stakeholders. The outcomes can be reviewed and acted upon to plan additional communication events, reduce the number of communication events, use a different communication medium, change the topics of the meeting, or in general provide information on the type of project communications.

The figures are block diagrams that illustrate a logical flow of the defined process. The blocks represent one or more operations that can be implemented in hardware, software, or a combination of hardware and software. The software operations are computer-executable instructions stored in computer-readable media that, when executed by one or processors performed the defined operations. The computer-executable instructions include programs, objects, functions, data structures, and components that perform actions based upon instructions. The order of presentation of the figures and process flows is not intended to limit or define the order in which the operations can occur. The processes can be executed in any order or in parallel. The processes described herein can be performed by resources associated with computing devices 702 or computer servers 720. The methods and processes described in this disclosure can be fully automated with software code programs executed by one or more general-purpose computers or processes. The code programs can be stored in any type of computer-readable storage medium or other computer storage device.

While this disclosure contains many specific details in the process flows, these are not presented as limitations on the scope or what may be claimed. These details are a description of features that may be specific to a particular process of particular inventions. Certain features that are described in this process flow in the context of separate figures may also be implemented as a single or a combined process. Features described as a single process flow may also be implemented in multiple processes flows separately or in any suitable combination. Furthermore, although features may be described as combinations in the specification or claims, one or more features may be added to or removed from the combination and directed to an alternative combination or variation of a combination.

What is claimed:

1. A method for transforming electronic communications into prediction of a project outcome, a computer implemented method comprising:
receiving an electronic communication through a network to a computer from a first application;
creating, by the computer, a commAnalysis table by selecting a minimal set of metadata from the electronic communication comprised of entity_1, entity_2, date, location identifier, and subject; selecting a subset of electronic communication where entity_1 or entity_2 have a corresponding record in a stakeholder table; adding a communication type attribute of “email” or “calendar” based on a source of the electronic communication; adding attributes comprised of year, month, week, day of the month, day of the week based on an the date; adding attributes comprised of role, group, and level for a stakeholder_1 from the stakeholder table based on the entity_1; adding attributes comprised of role, group, and level for a stakeholder_2 from the stakeholder table based on the entity_2, and adding location attributes comprised of location identifier and classification with a location identifier that match one in a location table;
executing, by the computer, a topic model that is a data mining program to assign a topic identifier, topic label, and topic group to the commAnalysis table based on subject attribute; executing a network program to create a vertex table, an edge table, and network metrics based on a vertex parameter; execute a frequency program to to compute frequencies of communication between two vertexes in the commAnalysis table; executing a medium program to compute a location frequency and a communication type frequency between two vertexes in the commAnalysis table; and executing a pattern program to compute a predicted adequacy score.

2. A computer implemented method as in claim 1, wherein
an electronic communications first application includes email messages and calendar events are a batch process;
wherein the vertex parameter is set to stakeholder role; and
wherein a predicted adequacy score is computed using a formula ((written+verbal)+(fixed interval+variable interval)*3+(written status+verbal update, average of written and verbal analysis))/11.

3. A computer implemented method as in claim 1, wherein
an electronic communications first application includes email messages and calendar events are a streaming process;
wherein the vertex parameter is set to stakeholder role; and
wherein a predicted adequacy score is is computed using a formula ((written+verbal)+(fixed interval+variable interval)*3+(written status+verbal update, average of written and verbal analysis))/11.

4. A method as in claim 1, wherein a predicted adequacy score is output, by the computer, to a prediction interface that includes a display area that is shown on computing devices with frequency, content, medium, and predicted adequacy score in a color-coded circle with a large, centered number for each stakeholder and overall project.

5. A system for transforming electronic communications into prediction of a project outcome, a computer implemented system comprising:
receiving an electronic communication through a network to a computer from a first application a minimal set of metadata from for email messages and for calendar events;
creating and storing, by the computer, a commAnalysis table by selecting a minimal set of metadata from the electronic communication comprised of entity_1, entity_2, date, location identifier, subject, and location;
selecting, by the computer, a subset of electronic communication where entity_1 or entity_2 have a corresponding record in a stakeholder table;
adding, by the computer, a communication type attribute of “email” or “calendar” based on a source of the electronic communication; adding attributes comprised of year, month, week, day of the month, day of the week based on the date;
adding, by the computer, attributes comprised of role, group, and level for a stakeholder_1 from the stakeholder table based on the entity_1;
adding, by the computer, attributes comprised of role, group, and level for a stakeholder_2 from the stakeholder table based on the entity_2;
adding, by the computer, location attributes comprised of location identifier and classification from a location table based on the location identifier;
executing, by the computer, a topic model that is a data mining program to assign a topic identifier, topic label, and topic group to the commAnalysis table based on subject attribute;
executing, by the computer, a network program to create a vertex table, an edge table, and network metrics based on a vertex parameter;
executing, by the computer, a frequency program to compute frequencies of communication between two vertexes in the commAnalysis table;
executing, by the computer, a medium program to compute a location frequency and a communication type frequency between two vertexes in the commAnalysis table;
executing, by the computer, an exfreq program to compute frequencies of engagement for vertexes in phase providing a phase score and phase label;
executing, by the computer, the exfreq program to compute frequencies of engagement for a milestone providing a milestone score and milestone label;
executing, by the computer, an direction program to compute a direction of communication between vertexes in a commAnalysis table and storing results in the edge table;
executing, by the computer, a sentiFreq program that is a data mining program to compute a sentiment analysis between two vertexes and store it in the edge table;
executing, by the computer, a demographics program to compute attributes comprised of start date, end date, duration, number of stakeholders, number of roles;
executing, by the computer, a pattern program to compute a predicted adequacy score for each vertex and overall project wherein a predicted adequacy score is is computed using a formula ((written+verbal)+(fixed interval+variable interval)*3+(written status+verbal update, average of written and verbal analysis))/11; and
executing, by the computer, a prediction interface that includes a display area that is shown on computing devices with the state of communication for each vertex and for overall project.

6. A system as in claim 5, wherein the vertex parameter is stakeholder role and executing, by the computer, the prediction interface that includes a display area that is shown on computing devices with a state of communication for each vertex and for overall project.

7. A system as in claim 5, wherein the vertex parameter is stakeholder identifier and outputting, by the computer, a visualization report that includes a social network analysis using the vertex table and the edge table.

8. A system as in claim 5, wherein the vertex parameter is stakeholder group and executing, by the computer, the prediction interface that includes a display area that is shown on computing devices with a state of communication for each vertex and for overall project.

9. A system as in claim 5, wherein the vertex parameter is stakeholder group and outputting, by computer, a visualization report that includes a social network analysis using the vertex table and the edge table.

10. A system for transforming electronic communications into prediction of a project outcome, a computer implemented system comprising:
receiving an electronic communication through a network to a computer from a first application a minimal set of metadata from for email messages and for calendar events are a batch process;
creating and storing, by the computer, a commAnalysis table by selecting a minimal set of metadata from the electronic communication comprised of entity_1, entity_2, date, location identifier, subject, and location;
selecting, by the computer, a subset of electronic communication where entity_1 or entity_2 have a corresponding record in a stakeholder table;
adding, by the computer, a communication type attribute of “email” or “calendar” based on a source of the electronic communication; adding attributes comprised of year, month, week, day of the month, day of the week based on the date;
adding, by the computer, attributes comprised of role, group, and level for a stakeholder_1 from the stakeholder table based on the entity_1;
adding, by the computer, attributes comprised of role, group, and level for a stakeholder_2 from the stakeholder table based on the entity_2;
adding, by the computer, location attributes comprised of location identifier and classification from a location table based on the location identifier;
executing, by the computer, a topic model that is a data mining program to assign a topic identifier, topic label, and topic group to the commAnalysis table based on subject attribute;
executing, by the computer, a network program to create a vertex table, an edge table, and network metrics based on a vertex parameter wherein the vertex parameter is set to stakeholder role;
executing, by the computer, a frequency program to compute frequencies of communication between two vertexes in the commAnalysis table;
executing, by the computer, a medium program to compute a location frequency and a communication type frequency between two vertexes in the commAnalysis table;
executing, by the computer, an exfreq program to compute frequencies of engagement for vertexes in phase providing a phase score and phase label;
executing, by the computer, the exfreq program to compute frequencies of engagement for a milestone providing a milestone score and milestone label;
executing, by the computer, an direction program to compute a direction of communication between vertexes in a commAnalysis table and storing results in the edge table;
executing, by the computer, a sentiFreq program that is a data mining program to compute a sentiment analysis between two vertexes and store it in the edge table;
executing, by the computer, a demographics program to compute attributes comprised of start date, end date, duration, number of stakeholders, number of roles;
executing, by the computer, a pattern program to compute a predicted adequacy score for each vertex and overall project wherein a predicted adequacy score is is computed using a formula ((written+verbal)+(fixed interval+variable interval)*3+(written status+verbal update, average of written and verbal analysis))/11; and
executing, by the computer, a prediction interface that includes a display area that is shown on computing devices with the state of communication for each vertex and for overall project.
